(19) United States
(12) Patent Application Publication
(10) Pub. No.: US 2026/0208673 A1
(43) Pub. Date: Jul. 23, 2026

(54) REFLECTOR FOR IN-CABIN MONITORING SYSTEMS

(71) Applicant: Gentex Corporation, Zeeland, MI (US)

(72) Inventors: Kasen Keith Anderson, Jenison, MI (US); Steven J. Veenman, Hudsonville, MI (US); Michael F. Lisowski, Holland, MI (US)

(73) Assignee: Gentex Corporation, Zeeland, MI (US)

(21) Appl. No.: 19/444,320

(22) Filed: Jan. 9, 2026

Related U.S. Application Data
(60) Provisional application No. 63/747,397, filed on Jan. 21, 2025.

(51) Int. Cl. B60R 1/12; B60R 1/04; B60R 1/08; B60R 1/29

(52) U.S. Cl. CPC B60R 1/1207; B60R 1/04; B60R 1/08; B60R 1/29; B60R 2001/1215; B60R 2001/1253; B60R 2300/8006

(57) ABSTRACT

A rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module and at least one illuminator that is connected to the first PCB and facing a direction of the viewing surface. A reflective element is proximate the at least one illuminator. The reflective element is located between the at least one illuminator and the upper edge of the primary housing and configured to redirect and spread a portion of a light from the at least one illuminator within an interior cabin of an automobile.

### CROSS REFERENCE TO RELATED APPLICATION

This application claims priority under 35 U.S.C. § 119(e) upon U.S. Provisional Ser. No. 63/747,397 , entitled “REFLECTOR FOR IN-CABIN MONITORING SYSTEMS,” filed on Jan. 21, 2025, the entire disclosure of which is incorporated herein by reference.

### FIELD OF THE DISCLOSURE

The present disclosure generally relates to a rearview mirror assembly and, more particularly, to a rearview mirror assembly with an in-cabin monitoring system that includes an optical element for redirecting and spreading light from an illuminator.

### SUMMARY OF THE DISCLOSURE

According to one aspect of the present disclosure, a rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module and at least one illuminator that is connected to the first PCB and facing a direction of the viewing surface. A reflective element is proximate the at least one illuminator. The reflective element is located between the at least one illuminator and the upper edge of the primary housing and configured to redirect and spread a portion of a light from the at least one illuminator within an interior cabin of an automobile.

According to another aspect of the present disclosure, a rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module, a first set of illuminators connected to the first PCB proximate one of the pair of side edges, and a second set of illuminators connected to the first PCB proximate one of the pair of side edges opposite the first set of illuminators. A first reflective element is located between the first set of illuminators and the upper edge of the primary housing and a second reflective element is located between the second set of illuminators and the upper edge of the primary housing. The first and second reflective elements are configured to redirect and spread an infrared illumination from the first and second set of illuminators within an interior cabin of an automobile.

According to still another aspect of the present disclosure, a rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module and at least one illuminator that is connected to the first PCB and facing a direction of the viewing surface. A reflective element is proximate the at least one illuminator. The reflective element is located between the at least one illuminator and the upper edge of the primary housing and includes a top element surface and a bottom optical surface. The bottom optical surface defines a reflective segment facing the at least one illuminator. The reflective segment defines a non-planar shape including a plurality of optical pillows that redirect and spread a light from the at least one illuminator towards a lower region of a vehicle cabin.

The present disclosure generally provides a rearview mirror assembly and, more particularly, to a rearview mirror assembly with an in-cabin monitoring system that includes an optical element for redirecting and spreading light from an illuminator. More particularly, in-cabin monitoring systems may employ one or more illuminators that are directed towards an occupant region. Light from the illuminators can be captured by an image capturing module. However, the illuminators, unless provided in great numbers at the cost of efficiency, cannot project light into regions of the interior cabin of a vehicle that may be of interest to monitor, such as a lower region. In this manner, the optical element may be used to reflect at least some light towards the lower regions of the vehicle cabin to, for example, monitor the feet, air bag, and/or the like during usage.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an interior view of a vehicle that includes a rearview mirror assembly in accordance with an aspect of the present disclosure;

FIG. 2 is a front, partially schematic view of a rearview mirror assembly in accordance with an aspect of the present disclosure;

FIG. 3A is a front view of a rearview mirror assembly with a pair of reflective optics and sets of illuminators in accordance with an aspect of the present disclosure;

FIG. 3B is an enlarged front perspective view of a reflective optic in a rearview mirror assembly in accordance with an aspect of the present disclosure;

FIG. 4 is a cross-sectional side view of a rearview mirror assembly in accordance with an aspect of the present disclosure; and

FIG. 5 is a schematic view of a control system of a rearview mirror assembly in accordance with an aspect of the present disclosure.

### DETAILED DESCRIPTION

The present illustrated embodiments reside primarily in combinations of method steps and apparatus components related to a rearview mirror assembly and, more particularly, to a rearview mirror assembly with an in-cabin monitoring system that includes an optical element for redirecting and spreading light from an illuminator. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

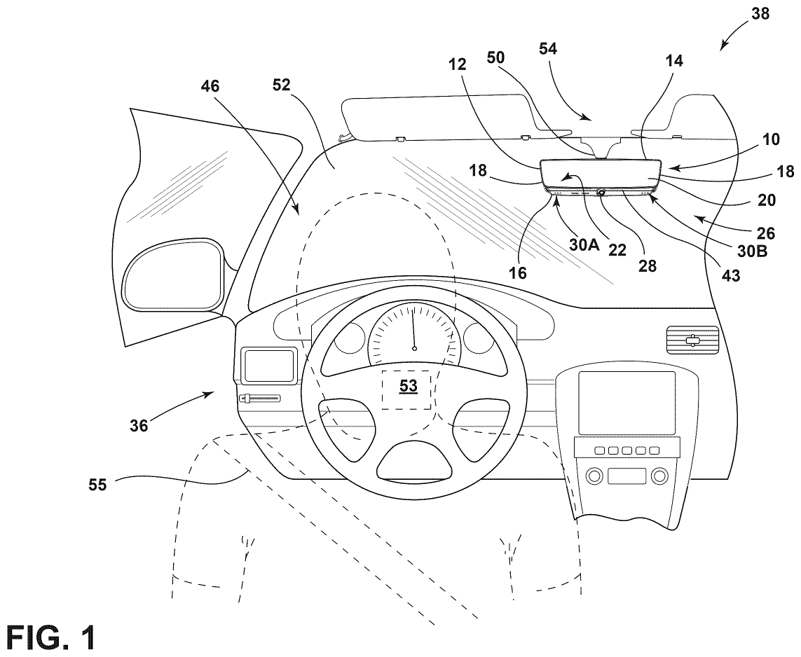

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

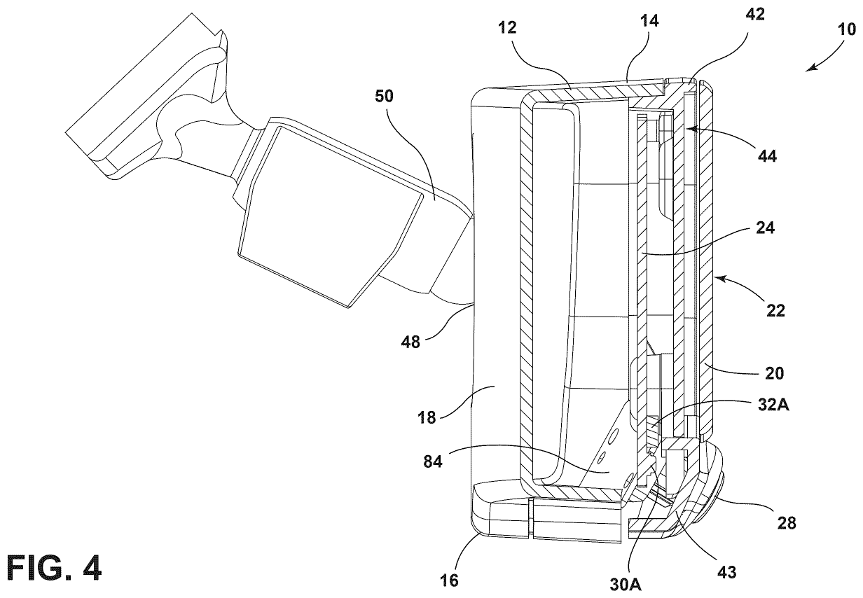

Referring initially to FIGS. 1-4, reference numeral 10 generally designates a rearview mirror assembly. The rearview mirror assembly 10 includes a primary housing 12 and has an upper edge 14 and a lower edge 16, which may be spaced by a pair of side edges 18. A glass element 20 is coupled to the primary housing 12 and defines a viewing surface 22. A first printed circuit board 24 (PCB) is located, at least in part (e.g., fully or partially), in the primary housing 12 (FIG. 4). A monitoring system 26 includes an image capturing module 28 and at least one illuminator 30A, 30B that is connected to the first PCB 24 (e.g., proximate the lower edge 16 of the primary housing 12, a lower edge of the glass element 20, and/or other locations relative to the glass element 20) and generally faces a direction of the viewing surface 22. A reflective element 32A, 32B is proximate the at least one illuminator 30A, 30B. The reflective element 32A, 32B is located between the at least one illuminator 30A, 30B and the upper edge 14 of the primary housing 12 and configured to redirect and spread a portion of a light 34 from the at least one illuminator 30A, 30B within an interior cabin 36 of an automobile 38.

With continued reference to FIGS. 1-4, the configuration of the rearview mirror assembly 10 permits coupling the at least one illuminator 30A, 30B to the first PCB 24 and redirecting and spreading the light 34. In this manner, the at least one illuminator 30A, 30B does not need any designated PCB other than the PCB 24, which may be configured to operate various other components of the rearview mirror assembly 10. While the rearview mirror assembly 10 is depicted and largely defined as being incorporated in a rearview mirror for the automobile 38, the rearview mirror assembly 10 may be incorporated into other environments. For example, in some embodiments, components of the rearview mirror assembly 10 may be incorporated in an emergency vehicle, a residential vehicle, an airplane, a rail vehicle, or the like. Generally speaking, the rearview mirror assembly 10 may be incorporated into any environment wherein monitoring the occupant position 46 may be beneficial. The rearview mirror assembly 10 may be configured as a full display rearview mirror and include a display module 40 behind the glass element 20 and within the primary housing 12. The display module 40 may be configured to generate messages, images, and/or the like to a vehicle operator. The display module 40 may occupy the entire (i.e., substantially match the perimeter) of the glass element 20. In some embodiments, the glass element 20 may include an electro-optic component 41 (e.g., an electrochromic component), including an electro-optic medium located between a pair of opposing substrates. The electro-optic medium may be switchable between a substantially transmissive state, a substantially darkened or opaque state, and intermediary states. The electro-optic component 41 may occupy the entire (i.e., substantially match the perimeter) of the glass element 20. In some embodiments, one or more reflective layer is located in or proximate to the glass element 20 for operating as a mirror. The reflective layer may include, for example, an absorptive polarizer, a reflective polarizer, and a liquid crystal element located between the absorptive polarizer and the reflective polarizer. The one or more reflective layers may occupy the entire (i.e., substantially match the perimeter) of the glass element 20.

In some implementations, the primary housing 12 may include a chin housing 43 and the at least one illuminator 30A, 30B may be located in the chin housing 43 that extends along and at least partially defines the lower edge 16 of the primary housing 12. In other words, the at least one illuminator 30A, 30B may be located proximate a bottom edge of the glass element 20. In some implementations, the first PCB 24 may be at least partially located in the chin housing 43. For example, the first PCB 24 may be located fully in the chin housing 43, located in both the chin housing 43 and the primary housing 12 portion, or fully within the primary housing 12 portion. The primary housing 12 of the rearview mirror assembly 10 may include a bezel or carrier element 42 that defines an opening 44 (FIG. 4) for locating and securing the glass element 20. The glass element 20 includes the viewing surface 22 that faces the occupant position 46 and a rear surface that generally faces away from the occupant position 46 within the interior cabin 36. The primary housing 12 may include a connection hub 48 and the connection hub 48 may be coupled to a mounting member 50. The mounting member 50 is configured to be coupled to the automobile 38 (e.g., a front window 52 or overhead area 54) and the primary housing 12 is moveable relative to the mounting member 50 to orient the glass element 20 at various angles relative to an occupant position 46 to obtain different environmental views and/or orientations relative to the interior cabin 36. As will be described in greater detail below, the monitoring system 26 may be configured to capture, detect, and utilize information (e.g., from the image capturing module 28 and light 34) and modify certain vehicular settings and/or generate certain warnings, such as settings or notifications related to an air bag 53, settings or notifications related to a condition of a seatbelt 55, etc.

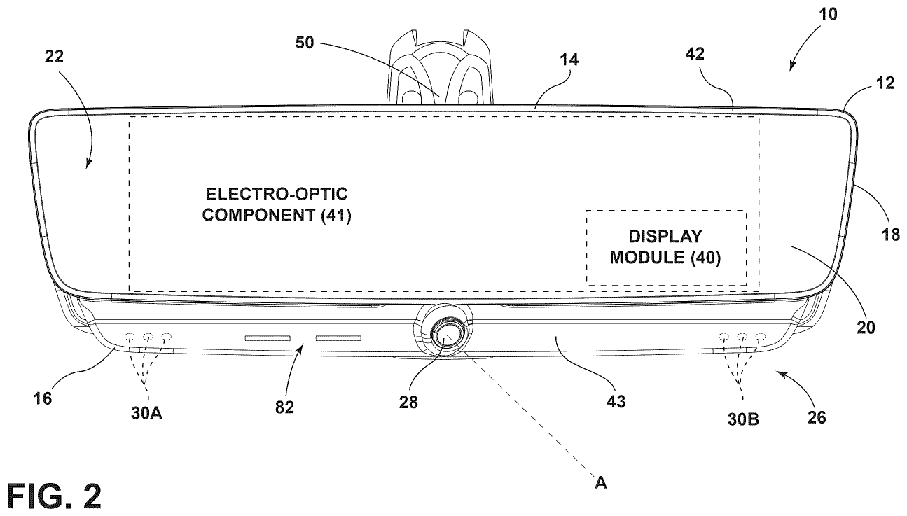

In the depicted arrangement in FIG. 2, the at least one illuminator 30A, 30B includes a plurality of illuminators 30A, 30B. The plurality of illuminators 30A, 30B may include a first set of illuminators 30A and a second set of illuminators 30A, 30B. Likewise, the reflective elements 32A, 32B may include a first reflective element 32A located proximate the first set of illuminators 30A and a second reflective element 32B located proximate the second set of illuminators 30B. More particularly, the first reflective element 32A may be located between the first set of illuminators 30A and the upper edge 14 of the primary housing 12 and the second reflective element 32B may be located between the second set of illuminators 30B and the upper edge of the primary housing 12. The first set of illuminators 30A and the first reflective element 32A may be located proximate to one of the side edges 18 and the second set of illuminators 30B and the second reflective element 32B may be located proximate to the other one of the side edges 18. In this manner, the position and groupings of the reflective elements 32A, 32B and the sets of illuminators 30A, 30B can be configured to direct and spread at least part of the light 34 towards not only the occupant positions 46 depicted in FIG. 1, but also a passenger position and other locations around the interior cabin 36. Each set of illuminators 30A, 30B may include one, two, three, four, or more individual illuminators 30A, 30B spaced along the lower edge 16. The illuminators 30A, 30B may generally face the direction of the viewing surface 22. For example, the illuminators 30A, 30B may be forward-facing, such that when the rearview mirror assembly 10 is installed in the automobile 38, the illuminators 30A, 30B generally project the light 34 in a direction that the viewing surface 22 faces. The illuminators 30A, 30B may generally be configured to project the light 34 in the infrared or near infrared spectrum. In some implementations, the light 34 is a flood illumination.

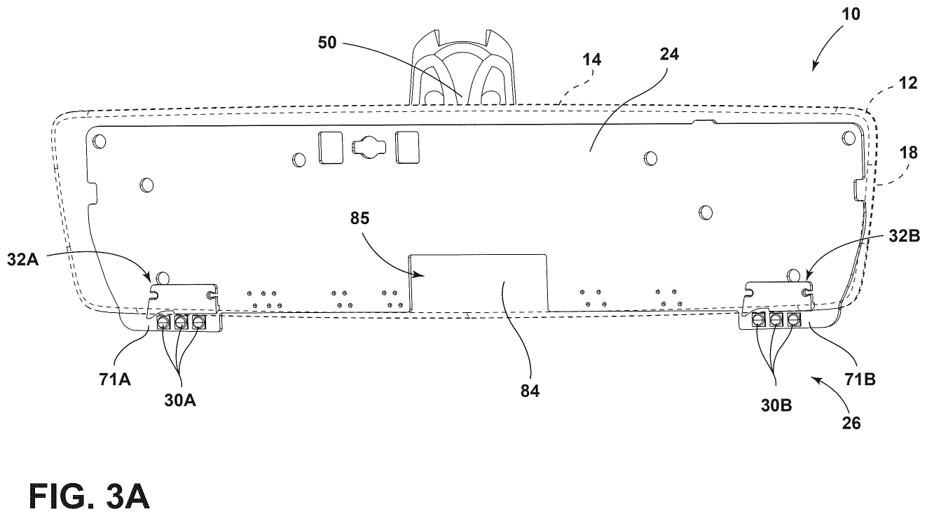

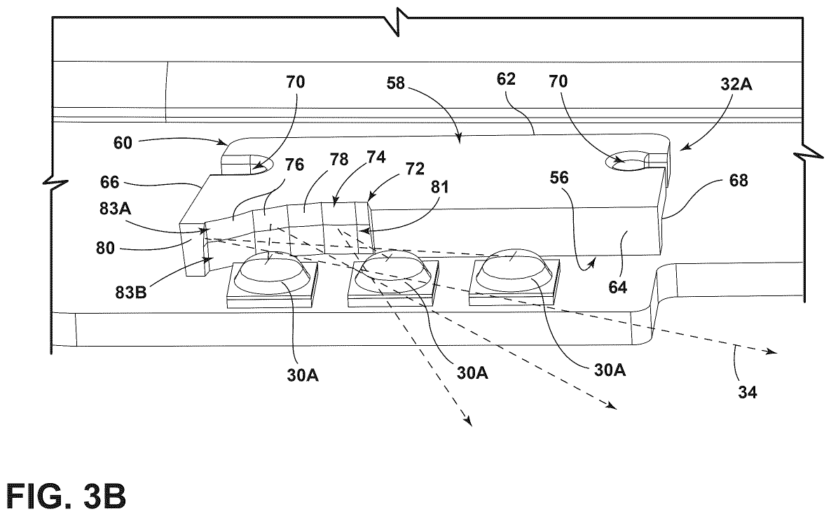

With reference to FIGS. 3A-4, the first reflective element 32A and the first set of illuminators 30A are depicted. It should be appreciated that the orientation, shape, and structure of the second reflective element 32B and the first set of illuminators 30A may generally be the same as the first reflective element 32A and the first set of illuminators 30A. In other words, the first reflective element 32A and the second reflective element 32B may each be generally asymmetric in shape and in the same orientation proximate opposite side edges 18 (e.g., the first reflective element 32A and the second reflective element 32B are not mirrored along a centerline of the rearview mirror assembly 10). However, in some implementations, the first reflective element 32A and the second reflective element 32B may be mirrored where the leftmost side of the reflective element 32A (e.g., defining tail 80 in FIGS. 3A and 3B) is closer to a left side edge 18 and a rightmost side of the reflective element 32B (e.g., defining tail 80) is closer to a right side edge 18. In further implementations, the reflective elements 32A, 32B may be flipped such that the tails 80 may be located on an edge of the reflective element 32A, 32B facing inwardly towards a centerline through the glass element 20. However, it should be appreciated that the reflective elements 32A, 32B may not be mirrored and be in the same general orientation but spaced along the bottom edge of the glass element 20. In some implementations, the first reflective element 32A (e.g., and the first illuminators 30A) may be fully or at least partially within a region occupying 30% a length of the lower edge 16 proximate the left side edge 18 and the second reflective element 32B (e.g., and the second illuminators 30B) may be fully or at least partially within a region occupying 30% a length of the lower edge 16 proximate the right side edge 18. For example, the regions may occupy 25% a length of the lower edge 16, 20% a length of the lower edge 16, 15% a length of the lower edge 16, 10% a length of the lower edge 16, or ranges between these values.

The reflective element 32 may include a rear element surface 56 facing the first PCB 24 or generally in a direction of the first PCB 24 and a front element surface 58 facing the glass element 20 or generally in a direction of the glass element 20. The rear element surface 56 and the front element surface 58 may define an outer optical perimeter 60. The optical perimeter 60 may include a top element surface 62, a bottom optical surface 64 (e.g., bottom element surface), a first side element surface 66, and a second side element surface 68. In some implementations, at least one or both of the rear element surface 56 and the front element surface 58 may be generally planar. More particularly, the reflective elements 32A, 32B may be generally configured to redirect and spread a portion of the light 34 from the bottom optical surface 64 only. In this manner, the rear element surface 56 and the front element surface 58 may be generally planar or flat to improve packaging and spacing requirements between the glass element 20 and the first PCB 24. Both the illuminators 30A, 30B and the reflective elements 32A, 32B may be directly connected to the first PCB 24. More particularly, the reflective elements 32A, 32B may each include openings 70 that receive pins or fasteners into like openings in the first PCB 24. The rear element surface 56 may abut the first PCB 24. In some implementations, as best depicted in FIG. 3A, the first PCB 24 may be located, at least in part, in the primary housing 12 and include at least one projection 71A, 71B that extends from a bottom surface of the primary housing 12 into and/or in alignment with the chin housing 43. In this manner, the illuminators 30A, 30B may be located on the at least one projection 71A, 71B and oriented towards the chin housing 43 (e.g., a front surface of the chin housing 43 that generally faces the occupant region). The at least one projection 71A, 71B may include two or more projections including a first projection 71A that is coupled to the first illuminators 30A and a second projection 71B that is coupled to the second illuminators 30B. The first and second projections 71A, 71B may be located in (e.g., confined in or in overlapping relationship with) the previously described regions occupying a length of the lower edge 16. The first and second projections 71A, 71B may be spaced from one another along the lower edge 16.

With continued reference to FIGS. 3A-4, the bottom optical surface 64 may define a reflective segment 72 facing the illuminators 30A. As will be described in greater detail, the reflective segment 72 may define a non-planar shape that redirects and spreads a portion of the light 34 from the illuminators 30A. The reflective segment 72 may only redirect and spread a portion of the light 34 as a significant portion of the light 34 from the forward facing illuminators 30A is already directed towards the interior cabin 36 and, more particularly, in a direction that the viewing surface 22 faces. However, a portion of the light 34 from the illuminators 30A will be generated upwards towards the reflective segment 72 where that portion can be redirected and spread. It should be appreciated that the entire reflective element 32A, the entire bottom optical surface 64 only, and/or the entire reflective segment 72 only may be reflective. The reflective segment 72 defines a recess 74 in the bottom optical surface 64 extending towards the top element surface 62. The recess 74 extends from the rear element surface 56 to the front element surface 58 and defines part of the outer optical perimeter 60.

The recess 74 may be generally curved along the bottom optical surface 64 between the first and second side element surfaces 66, 68. More particularly, the recess 74 may be proximate or adjacent to the first side element surface 66 and spaced from the second side element surface 68 may be a portion of the bottom optical surface 64. In addition to generally curving between the first and second side element surfaces 66, 68 the recess 74 may also be generally curved between the rear element surface 56 and the front element surface 58. In other words, the reflective segment 72 may generally be shaped similarly to the inside of a segment of a torus and, more particularly, a polygonal torus. However, unlike a standard polygonal torus made up of planar segments, recess 74 may be generally defined by optical pillows 76. The optical pillows 76 may be spaced from one another and raised towards the bottom optical surface 64. More particularly, the optical pillows 76 may be curved or rounded towards a central region 78 extending generally towards the bottom optical surface 64 around the curvature of the recess 74.

In some implementations, the reflective segment 72 defines a tail 80 extending past the bottom optical surface 64. More particularly, the recess 74 may define the curved shape and extend along the bottom optical surface 64 and at least part of the tail 80 past the bottom optical surface 64. The tail 80 may extend at least partially around one of the illuminators 30A (e.g., past in the vertical direction). In some implementations, at least two of the illuminators 30A may be at least partially aligned with the reflective segment (e.g., between the first and second side element surfaces 66, 68.). Further, the reflective segment 72 may include a trench portion 81 extending towards the top element surface 62 spaced between the rear element surface 56 and the front element surface 58. More particularly, a first recess surface 83A extending from the front element surface 58 towards the rear element surface 56 and angled at least partially towards the top element surface 64 and a second recess surface 83B extending from the rear element surface 56 towards the front element surface 58, angled at least partially towards the top element surface 62, and merging at the trench portion 81. The first recess surface 83A and the second recess surface 83B may both be defined by the optical pillows 76.

As illustrated, the reflective segment 72 may be generally shaped to redirect and spread at least a portion of the light 34 towards the occupant (e.g., driver or passenger) region and, more particularly, towards a lower region of a vehicle cabin (e.g., the foot region and/or a region of the air bag 53). In some implementations, the image capturing module 28 may be oriented along an axis A that is at least partially aimed toward the occupant region. In this manner, if the rearview mirror assembly 10 is oriented toward the driver, the image capturing module 28 is still oriented to capture the foot region and/or the region of the air bag 53. It should be appreciated that the depicted arrangement is for vehicles with steering wheels on the left side and that the same features may be employed in vehicles with the steering wheel on the right side with or without flipping the orientation of the reflective elements 32A, 32B relative to the rearview mirror assembly 10. The orientation of the image capturing module 28, the structures of the reflective segment 72, and the side of the reflective optic 32A that has the tail 80, may be mirrored (e.g., reversed) in the opposite direction for right-handed vehicles. Further, in some implementations, the first reflective element 32A and the second reflective element 32B may be mirrored from each other along a center line of the rearview mirror assembly 10 (e.g., in left and right-handed vehicles and/or for other scenarios where the distribution of light 34 is beneficial).

With reference now to FIG. 4, the rearview mirror assembly 10 includes the first PCB 24 which may transverse (e.g., substantially parallel) at least part of the viewing surface 22. The first PCB 24 may be operably connected to the illuminators 30A, 30B. In some embodiments, the chin housing 43 or other areas of the rearview mirror assembly 10 may include a user interface 82 (FIG. 2) operably connected to the first PCB 24. In some embodiments, the user interface 82 has a dedicated PCB that is different than the first PCB 24. In some embodiments, the rearview mirror assembly 10 may further include a second PCB 84 that is operably connected to other components of the rearview mirror assembly 10. For example, the second PCB 84 may be operably connected to the image capturing module 28, the display module 40, and the electro-optic component 41. The second PCB 84 may be transverse to the first PCB 24 (e.g., substantially perpendicular to the viewing surface 22). In some embodiments, the image capturing module 28 includes a designated PCB (e.g., the second PCB 84 or a third PCB). The second PCB 84 and image capturing module 28 may be aligned with a bay 85 (FIG. 3A) defined in the first PCB 24 (e.g., between projections 71A, 71B).

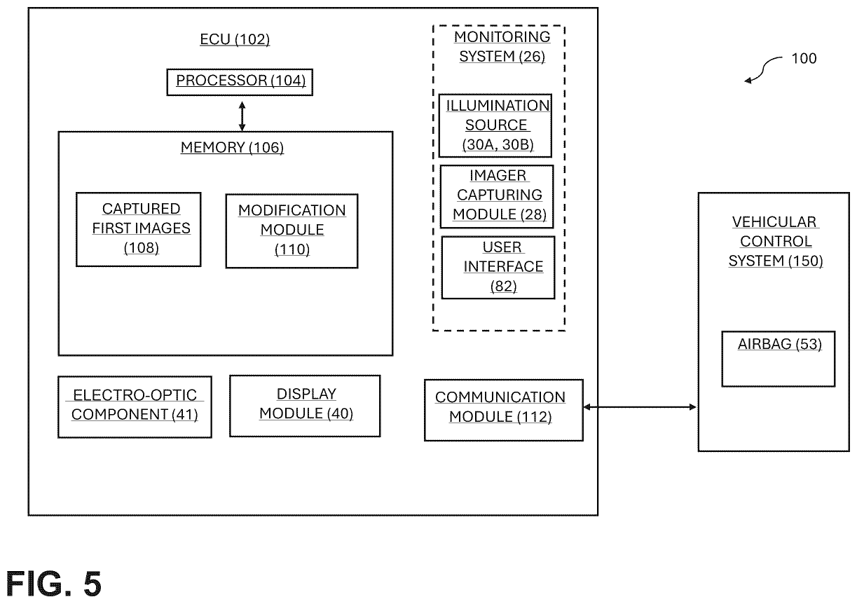

With reference now to FIG. 5, a control system 100 of the rearview mirror assembly 10 may include at least one electronic control unit (ECU) 102. The at least one ECU 102 may be located in the primary housing 12 and may be associated with the first PCB 24, the second PCB 84, additional PCBs, and/or combinations thereof. In some embodiments, components of the ECU 102 are located in both the primary housing 12, the chin housing 43, and/or other structures in the automobile 38. The at least one ECU 102 may include a processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid-state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the rearview mirror assembly 10. The illuminators 30A, 30B, image capturing module 28, the display module 40, the electro-optic component 41, and the user interface 82 may, therefore, be controlled by the control system 100. The memory 106 may, therefore, include a series of captured images 108, and a modification module 110. In some embodiments, the control system 100 may include a communication module 112 in operable communication with a vehicular control system 150.

In operation, the control system 100 may be configured to review the captured images 108 and monitor passenger or driver activity with respect to the region of the air bag 53 and/or the status of the seatbelt 55. While the proceeding examples use the passenger as an example, the same principles can be utilized for driver monitoring. For example, if the passenger is in contact with the region of the air bag 53, the control system 100 may (e.g., via the modification module 110) generate a signal (e.g., via the communication module 112) to the vehicular control system 150 to prevent deploying the air bag 53. Further, if the passenger is in contract with or within a proximity threshold, the control system 100 may be configured to generate a warning (audible and/or visual) to request the passenger move within a safe position with respect to the air bag 53 (e.g., outside the proximity threshold). In some implementations, the monitoring system 26 (e.g., the control system 100) is configured to regulate the deployment of the air bag 53 between a maximum deployment (e.g., when the passenger is outside the proximity threshold), a minimum deployment, and intermediary deployments. For example, when a passenger is within the proximity threshold but not in contact with the region of the air bag 53 (e.g., the surface defining the deployment origin), the minimum deployment and/or intermediary deployment may be utilized via communication with the vehicular control system 150. In some implementations, the deployment may be directly correlated to the passenger distance to the air bag 53, where the closer the passenger is to the air bag 53, the lower the deployment. In a similar manner, if the passenger or driver is not wearing or improperly wearing the seatbelt 55, the control system 100 may (e.g., via the modification module 110) generate a signal (e.g., via the communication module 112) to the vehicular control system 150 to generate a warning and may further modify the deployment of the air bag 53.

The disclosure herein is further summarized in the following paragraphs and is further characterized by combinations of any and all of the various aspects described therein.

According to one aspect of the present disclosure, a rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module and at least one illuminator that is connected to the first PCB and facing a direction of the viewing surface. A reflective element is proximate the at least one illuminator. The reflective element is located between the at least one illuminator and the upper edge of the primary housing and configured to redirect and spread a portion of light from the at least one illuminator within an interior cabin of an automobile.

According to yet another aspect, a reflective element includes a top element surface and a bottom optical surface, the bottom optical surface defining a reflective segment facing at least one illuminator, the reflective segment defining a non-planar shape that redirects and spreads the light from the at least one illuminator.

According to still another aspect, a reflective element includes a rear element surface facing a first PCB and a front element surface facing a glass element.

According to another aspect, the rear element surface and the front element surface are planar.

According to yet another aspect, a reflective element includes an outer optical perimeter including a top element surface, a bottom optical surface, a first side element surface, and a second side element surface.

According to still another aspect, a reflective segment defines a recess in a bottom optical surface extending towards a top element surface.

According to still yet another aspect, a bottom of the recess defines a trench portion extending towards a top element surface spaced between a rear element surface and a front element surface.

According to another aspect, a reflective segment includes a first recess surface extending from a front element surface towards a rear element surface and angled at least partially towards a top element surface.

According to still another aspect, a reflective segment includes a second recess surface extending from a rear element surface towards a front element surface, angled at least partially towards a top element surface, and merging at a trench portion.

According to still yet another aspect, a reflective segment includes a plurality of optical pillows spaced from one another and raised towards a bottom optical surface.

According to another aspect, a plurality of optical pillows are curved towards a central region extending towards a bottom optical surface.

According to still another aspect, a reflective segment defines a tail extending past a bottom optical surface.

According to still yet another aspect, a recess defines a curved shape extending along a bottom optical surface and at least part of a tail past the bottom optical surface.

According to another aspect, at least one illuminator includes at least two illuminators, the at least two illuminators at least partially aligned with a reflective segment.

According to another aspect of the present disclosure, a rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module, a first set of illuminators connected to the first PCB proximate one of the pair of side edges, and a second set of illuminators connected to the first PCB proximate one of the pair of side edges opposite the first set of illuminators. A first reflective element is located between the first set of illuminators and the upper edge of the primary housing and a second reflective element is located between the second set of illuminators and the upper edge of the primary housing. The first and second reflective elements are configured to redirect and spread an infrared illumination from the first and second set of illuminators within an interior cabin of an automobile.

According to another aspect, a first reflective element and a second reflective element each include a top element surface and a bottom optical surface, the bottom optical surface defining a reflective segment facing a respective set of illuminators, the reflective segment defining a curved shape that redirects and spreads the light from the respective set of illuminators.

According to still another aspect, a reflective segment of a first reflective element and a second reflective element both define a tail at least partially defining a recess and extending past a bottom optical surface.

According to still yet another aspect, a first and second reflective element includes a first side element surface facing one of a pair of side edges of a primary housing and a second side element surface facing the other one of the pair of side edges, wherein a tail is located in a direction the first element side surface in both the first and second reflective elements.

According to still another aspect of the present disclosure, a rearview mirror assembly includes a primary housing that has an upper edge and a lower edge. A glass element is coupled to the primary housing and defines a viewing surface. A first printed circuit board (PCB) is located, at least in part, in the primary housing. A monitoring system includes an image capturing module and at least one illuminator that is connected to the first PCB and facing a direction of the viewing surface. A reflective element is proximate the at least one illuminator. The reflective element is located between the at least one illuminator and the upper edge of the primary housing and includes a top element surface and a bottom optical surface. The bottom optical surface defines a reflective segment facing the at least one illuminator. The reflective segment defines a non-planar shape including a plurality of optical pillows that redirect and spread a light from the at least one illuminator towards a lower region of a vehicle cabin.

According to another aspect, a rearview mirror assembly includes a chin housing and a first PCB is located, at least in part, in the chin housing.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A rearview mirror assembly comprising:
a primary housing including an upper edge and a lower edge;
a glass element coupled to the primary housing and defining a viewing surface;
a first printed circuit board (PCB) located, at least in part, in the primary housing; and
a monitoring system comprising:
an image capturing module;
at least one illuminator connected to the first PCB and facing a direction of the viewing surface; and
a reflective element proximate the at least one illuminator, the reflective element located between the at least one illuminator and the upper edge of the primary housing and configured to redirect and spread a portion of a light from the at least one illuminator within an interior cabin of an automobile.

2. The rearview mirror assembly of claim 1, wherein the reflective element includes a top element surface and a bottom optical surface, the bottom optical surface defining a reflective segment facing the at least one illuminator, the reflective segment defining a non-planar shape that redirects and spreads the light from the at least one illuminator.

3. The rearview mirror assembly of claim 2, wherein the reflective element includes a rear element surface facing the first PCB and a front element surface facing the glass element.

4. The rearview mirror assembly of claim 3, wherein the rear element surface and the front element surface are planar.

5. The rearview mirror assembly of claim 3, wherein the reflective element includes an outer optical perimeter including the top element surface, the bottom optical surface, a first side element surface, and a second side element surface.

6. The rearview mirror assembly of claim 5, wherein the reflective segment defines a recess in the bottom optical surface extending towards the top element surface.

7. The rearview mirror assembly of claim 6, wherein a bottom of the recess defines a trench portion extending towards the top element surface spaced between the rear element surface and the front element surface.

8. The rearview mirror assembly of claim 7, wherein the reflective segment includes a first recess surface extending from the front element surface towards the rear element surface and angled at least partially towards the top element surface and a second recess surface extending from the rear element surface towards the front element surface, angled at least partially towards the top element surface, and merging at the trench portion.

9. The rearview mirror assembly of claim 6, wherein the reflective segment includes a plurality of optical pillows spaced from one another and raised towards the bottom optical surface.

10. The rearview mirror assembly of claim 9, wherein the optical pillows are curved towards a central region extending towards the bottom optical surface.

11. The rearview mirror assembly of claim 6, wherein the reflective segment defines a tail extending past the bottom optical surface.

12. The rearview mirror assembly of claim 11, wherein the recess defines a curved shape extending along the bottom optical surface and at least part of the tail past the bottom optical surface.

13. The rearview mirror assembly of claim 1, wherein the at least one illuminator includes at least two illuminators, the at least two illuminators at least partially aligned with the reflective segment.

14. A rearview mirror assembly comprising:
a primary housing including an upper edge and a lower edge spaced from the upper edge by a pair of side edges;
a glass element coupled to the primary housing and defining a viewing surface;
a first printed circuit board (PCB) located, at least in part, in the primary housing; and
a monitoring system comprising:
an image capturing module;
a first set of illuminators connected to the first PCB proximate one of the pair of side edges and a second set of illuminators connected to the first PCB proximate one of the pair of side edges opposite the first set of illuminators; and
a first reflective element located between the first set of illuminators and the upper edge of the primary housing and a second reflective element located between the second set of illuminators and the upper edge of the primary housing, the first and second reflective elements configured to redirect and spread an infrared illumination from the first and second set of illuminators within an interior cabin of an automobile.

15. The rearview mirror assembly of claim 14, wherein the first reflective element and the second reflective element each include a top element surface and a bottom optical surface, the bottom optical surface defining a reflective segment facing the respective set of illuminators, the reflective segment defining a curved shape that redirects and spreads the light from the respective set of illuminators.

16. The rearview mirror assembly of claim 15, wherein the reflective segments of the first reflective element and the second reflective element both define a tail at least partially defining the recess and extending past the bottom optical surface.

17. The rearview mirror assembly of claim 16, wherein the first and second reflective elements include a first side element surface facing one of the pair of side edges of the primary housing and a second side element surface facing the other one of the pair of side edges, wherein the tail is located in a direction of the first side element surface in both the first and second reflective elements.

18. The rearview mirror assembly of claim 14, wherein the first and second reflective elements are mirrored.

19. A rearview mirror assembly comprising:
a primary housing including an upper edge and a lower edge;
a glass element coupled to the primary housing and defining a viewing surface;
a first printed circuit board (PCB) located, at least in part, in the primary housing; and
a monitoring system comprising:
an image capturing module;
at least one illuminator connected to the first PCB and facing a direction of the viewing surface; and
a reflective element proximate the at least one illuminator, the reflective element located between the at least one illuminator and the upper edge of the primary housing and including a top element surface and a bottom optical surface, the bottom optical surface defining a reflective segment facing the at least one illuminator, the reflective segment defining a non-planar shape including a plurality of optical pillows that redirect and spread a light from the at least one illuminator towards a lower region of a vehicle cabin.

20. The rearview mirror assembly of claim 19, further including a chin housing and the first PCB is located, at least in part, in the chin housing.
